(19) United States
(12) Patent Application Publication
(10) Pub. No.: US 2010/0285431 A1
(43) Pub. Date: Nov. 11, 2010

(54) CROCHETED YARN MODEL ENABLING EASY, QUICK AND UNIFORM HAND KNIT HANDICRAFT PROJECTS

(75) Inventor: Mehmet Abdullah Sencopur, Istanbul (TR)

Correspondence Address: EGBERT LAW OFFICES, 412 MAIN STREET, 7TH FLOOR, HOUSTON, TX, 77002, US

(73) Assignee: YUNTEKS TEKSTIL SANAYIVE TICARET LIMITED SIRKETI, Merter-Gungore, Istanbul (TR)

(21) Appl. No.: 12/743,844

(22) PCT Filed: Dec. 5, 2007
(86) PCT No.: PCT/IB2007/003895

§ 371 Date: May 20, 2010

(30) Foreign Application Priority Data
Nov. 20, 2007 (TR) 2007/07988

(51) Int. Cl. G09B 19/20

(52) U.S. Cl. 434/95

(57) ABSTRACT

The present invention a crocheted yarn model enabling persons to make easy, quick and uniform hand knit like handicraft projects. Users will be able to make handicraft projects easily and uniformly in a very short period of time without any special skill or expertise.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention is related to the field of crocheting. More particularly, the present invention is related to a yarn model for making easy, quick, neat and uniform hand knit like handicraft projects.

2. Description of Related Art Including Information Disclosed under 37 CFR 1.97 and 37 CFR 1.98

Currently people have to know knitting or crocheting to make handicraft projects with yarn. The long duration of time needed for completing a project is also a disadvantage. Even if they use the same yarn the end quality of a project can vary according to knitting skills and expertise levels of people.

### BRIEF SUMMARY OF THE INVENTION

All these problems are solved by the invention of a crocheted yarn model. Even people who do not know how to knit or crochet or people who want to finish their projects quickly can make products like shawls, pullovers, cardigans, tablecloths, curtains, blankets, bedclothes, etc. People can finish their handicraft projects easily and uniformly in short time periods.

### BRIEF DESCRIPTION OF THE SEVERAL VIEWS OF THE DRAWINGS

FIG. 1 is a schematic view of the crocheted yarn model of the present invention.

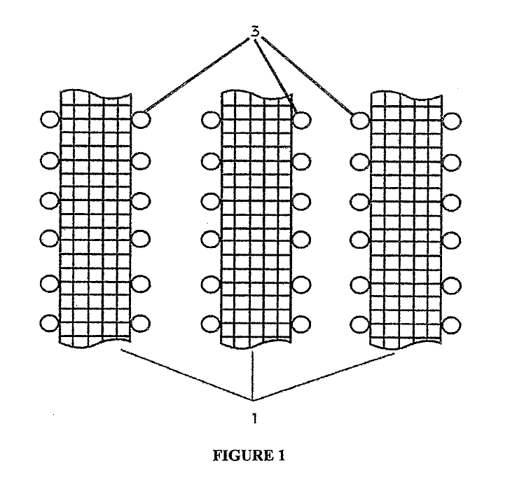

FIG. 2 is a schematic view of a product using the crocheted yarn model of the present invention.

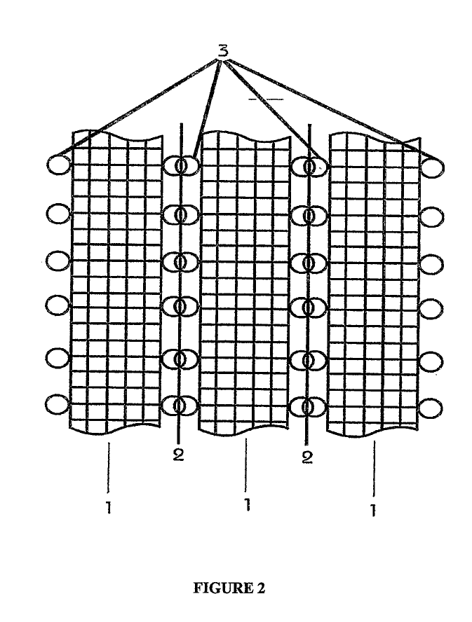

### DETAILED DESCRIPTION OF THE INVENTION

The present invention enables making easy, quick and uniform hand knit like handicraft projects.

There are loops (3) at top and bottom sides of the specially configured crocheted yarn model (1). Combining can be done easily by any kind of yarn (2) which is to be passed through the loops (3). So any project can be completed in a short time.

Various kinds of handicraft yarns can be produced with different configurations and content.

Difficult and long time consuming projects such as curtains, bedclothes, etc. and all kind of projects can be completed uniformly in a shorter time with no need of any skill or expertise. For example to make a window curtain or bed cloth by crocheting or hand knitting will take several months to finish. The same projects can be completed in 2-3 days without any need for skill and expertise.

1. A crocheted yarn model has loops at top and bottom sides enabling a very easy combining together by any kind of yarn to be passed through the loops, said crocheted yarn model enabling creation of handicraft projects quickly and uniformly in a very short time.
